(19) United States
(12) Patent Application Publication
(10) Pub. No.: US 2003/0128474 A1
(43) Pub. Date: Jul. 10, 2003

(54) Low electrical impedance slider grounding

(76) Inventors: Kevin J. Schulz, Apple Valley, MN (US); Keefe M. Russell, Robbinsdale, MN (US); Michael J. Gronseth, Bloomington, MN (US)

Correspondence Address: Intellectual Property Department - NRW-097, Seagate Technology LLC, 7801 Computer Avenue South, Bloomington, MN, 55435, US

(21) Appl. No.: 10/352,602

(22) Filed: Jan. 28, 2003

Related U.S. Application Data
(63) Continuation-in-part of application No. 10/290,178, filed on Nov. 8, 2002.
(60) Provisional application No. 60/338,178, filed on Nov. 9, 2001.

(51) Int. Cl. G11B 5/48

(52) U.S. Cl. 360/245.9

(57) ABSTRACT

An improved suspension assembly comprises a suspension, a slider and a ground trace. The suspension includes a load beam and a gimbal connected to a distal end of the load beam, the gimbal having a slider opposing face. The slider supports a transducing head and the slider supported by the slider opposing face of the gimbal. The slider includes a slider body having a gimbal opposing face and a disc opposing face, the slider body having a forward face extending between the gimbal opposing face and the disc opposing face. A slider bond pad and a slider ground pad are located on the forward face of the slider body. A ground trace is interconnected with the slider ground pad.

### CROSS-REFERENCE TO RELATED APPLICATION(S)

This application is a continuation-in-part of U.S. application Ser. No. 10/290,977, filed Nov. 8, 2002 for “Head Gimbal Assembly Plateau Gimbal Design” by Richard L. Segar, Jennifer A. Engebrit and Keefe M. Russell, which claims priority from and incorporates the entirety of provisional application No. 60/338,178 filed Nov. 9, 2001, for “HGA PLATEAU GIMBAL DESIGN” by Richard L. Segar, Jennifer A. Engebrit, and Keefe M. Russell.

### BACKGROUND OF THE INVENTION

The present invention relates to a head gimbal assembly. In particular, it relates to a low impedance ground connection from a slider to ground.

Air bearing sliders have been extensively used in disc drives to appropriately position a transducing head above a rotating disc. The transducing head is typically carried by the slider. Conventionally, head positioning is accomplished by operating an actuator arm with a large-scale actuation motor, such as a voice coil motor (VCM), to radially position the slider over a track on a disc. Typically, disc drive systems include a suspension assembly attached to the actuator arm for supporting and positioning the slider. The suspension assembly includes a load beam attached to the actuator arm and a gimbal disposed at the opposite end of the load beam. This type of suspension assembly is used with both magnetic and nonmagnetic discs. A flex circuit material is deposited on the suspension and the actuator arm. The air bearing slider carrying the transducing head is mounted to the flex circuit material. The VCM rotates the actuator arm and the suspension assembly to position the transducing head over a desired radial track of the disc.

In order for the disc drive to read and write data from the transducing head, conductive traces are disposed along the flex circuit material of the suspension assembly for the disc drive to electrically communicate with the slider. The traces extend along the gimbal and end at flex on suspension (FOS) bond pads formed adjacent to the slider. The slider has a forward face with bond pads disposed on the forward face such that an electrical connection can be made between the traces and the slider. Typically, gold ball bonds are used to provide the connection between the FOS bond pads and the slider bond pads.

The head gimbal assembly (HGA) product design evolved from a FOS over to a FOS under trace routing with the advent of HGA automation. A FOS over design employs a FOS on the non-disc side of the HGA with flying FOS traces tab bonded to the slider bond pads. The FOS over design results in a thin adhesive bondline between the slider and the stainless steel gimbal. Historically, this has provided consistent resistance performance required by the drive design. The HGA automation process requires a FOS under configuration, or FOS on the disc side of the suspension. This FOS under configuration implements a slider to FOS trace ball bond interconnect process. This configuration employs a layer of polyimide spaced between the slider and stainless steel gimbal. The increased slider to gimbal spacing increased the bondline resistance (to greater than 10⁸ ohms) and drove the requirement for new wafer level processes to compensate for slider to FOS trace alignment tolerances. Therefore, there is a need for an HGA that provides a small bondline resistance to improve BER (bit error rate), reduce system noise, and match ESD/EOS wafer design protection feature requirements.

A low impedance ground connection is required to reduce electrical noise in the read signal. The magnetic heads of the slider have a high degree of sensitivity to noise signals. Furthermore, stray capacitance due to the separation between the magnetic head and surrounding materials tends to limit the performance of magnetic storage systems using thin film magnetic heads. Particularly, during the read operation, the performance of the magnetic head (or transducing head) could be improved by eliminating stray capacitance and lowering the head sensitivity to noise signals from a surrounding environment.

As the slider follows the topography of the rotating disc, electrostatic charge accumulates on the slider and impedes performance of read and write operations between the transducer and the magnetic disc. An electrical conduction path between the slider and the suspension assembly is needed to prevent the accumulation of charge by grounding the slider to the suspension assembly.

It is important to provide an electrical ground to the transducing head through the actuation assembly to the chassis of the disc drive. This helps reduce the build-up of static electricity on the slider which can arc to the storage disc. Further, the electrical grounding of the slider helps reduce noise during the read back of magnetically encoded information.

Conductive adhesive, such as epoxy, has been used as an adhesive to mount the slider to the gimbal and provide the electrical conduction path. The adhesive connection tends to electrically insulate the slider from the gimbal. Conductive epoxy includes a mix of an epoxy and a conductive filler, such as silver particles. These particles are in contact with another and create a conductive chain between the slider and the gimbal. In order to create the conductive chain, the particles must be relatively large in size. As the slider is bonded to the gimbal, these large particles can prevent a parallel bond between the slider and the gimbal. This is a disadvantage because accurate positioning of the slider over individual data tracks on a rotating magnetic disc is essential to disc drive performance. In addition, the silver filler particles used in conductive epoxy reduce the overall bond strength of the epoxy and do not provide a good contact to the slider.

Another method of providing the electrical conduction path is to secure the slider to the gimbal with a non-conductive adhesive and then form conductive bridges which bridge the non-conductive adhesive connection. These conductive bridges can be formed by applying a secondary conductive fillet across the adhesive connection with the primary fillet being the non-conductive adhesive. Forming the secondary fillet creates an extra manufacturing step and increases production costs.

The mechanical properties of the gimbal bond adhesive used between the slider and the steel gimbal need to be carefully controlled to provide large sheer strength and low stress on the slider, which would induce shape changes to the air bearing surface. For a conductive adhesive to be effective requires high percentages of conductive filler and high internal stress to pull the conductive material into contact with the mating surface. These properties result in both a low gimbal bond sheer properties and large slider shape changes. Solutions have been tried which improve adhesive electrical contact between the slider and the gimbal and the ability to optimize electrical mechanical adhesive properties.

In typical prior art disc drives, average resistivity of head gimbal assemblies, as measured between the head assembly and the gimbal assembly in which the head assembly is attached to the gimbal assembly through a conductive adhesive, can range up to 10⁶ Ohms (Ω). Thus, there is a need in the art for an electrical ground in a disc drive with a low resistivity or impedance which is easy to manufacture.

### BRIEF SUMMARY OF THE INVENTION

The present invention relates to an improved suspension assembly comprised of a suspension including a load beam and a gimbal connected to a distal end of the load beam, the gimbal having a slider opposing face. The suspension assembly further includes a slider supporting a transducing head and the slider supported by a slider opposing face of the gimbal. The slider includes a slider body having a gimbal opposing face and a disc opposing face, the slider body having a forward face extending between the gimbal opposing face and the disc opposing face. A slider bond pad and a slider ground pad are located on the forward face of the slider body. A ground trace is interconnected with the slider ground pad.

### BRIEF DESCRIPTION OF THE DRAWINGS

FIG. 1 shows a top perspective view of a disc drive actuation system for positioning a slider over tracks of a disc.

FIG. 2 shows a portion of the disc drive actuation system.

FIG. 3 shows an exploded perspective view of a distal portion of the disc drive actuation system of FIG. 2.

FIG. 4A shows a bottom view of one embodiment of an assembled distal portion of the disc drive actuation system of FIG. 3.

FIG. 4B shows perspective view of the assembled distal portion of the disc drive actuation system of FIG. 4A.

FIG. 5 shows a bottom view of another embodiment of an assembled distal portion of the disc drive actuation system of FIG. 3.

FIG. 6 shows a bottom view of the embodiment of the assembled distal portion of the disc drive actuation system of FIG. 5.

FIG. 7 shows a perspective view of the distal portion of a flex circuit of the disc drive actuation system of FIG. 5.

### DETAILED DESCRIPTION

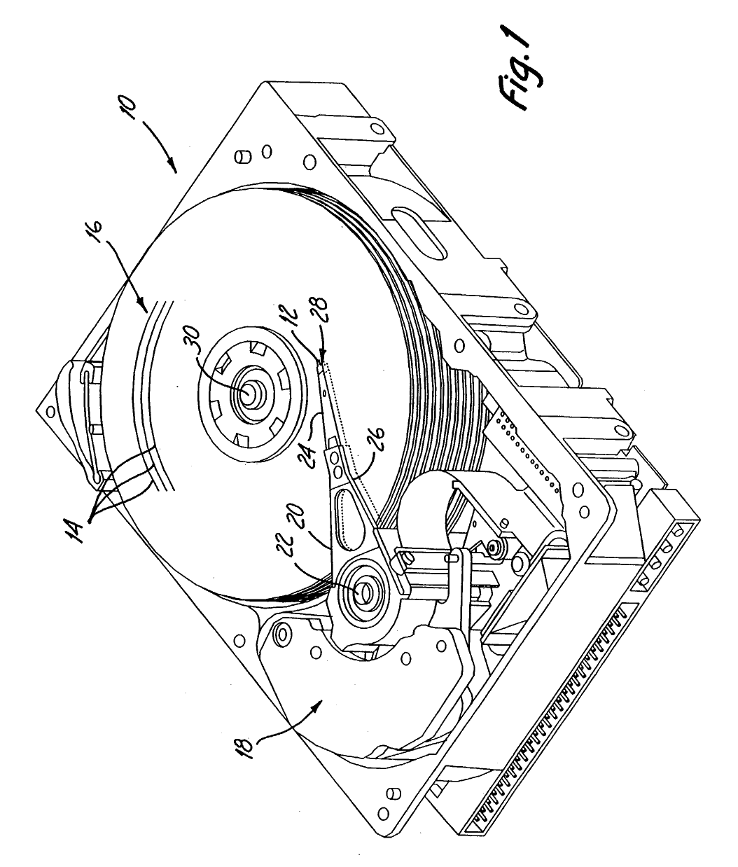

FIG. 1 is a perspective view of a disc drive 10 including an actuation assembly for positioning a slider 12 over a track 14 of a disc 16. Disc drive 10 includes a voice coil motor (VCM) 18 arranged to rotate an actuator arm 20 on a spindle around an axis 22. A load beam 24 is connected to actuator arm 20 at a head mounting block 26. A gimbal 28 is connected to an end of load beam 24 and slider 12 is attached to gimbal 28. Slider 12 carries a transducing head (not shown in FIG. 1) for reading and/or writing data on concentric tracks 14 of disc 16. Disc 16 rotates around an axis 30 so that windage is encountered by slider 12 to keep it aloft a small distance above the surface of disc 16. FIG. 1 shows a disc drive having an upper and lower actuation assembly, with the lower actuation assembly being shown in phantom.

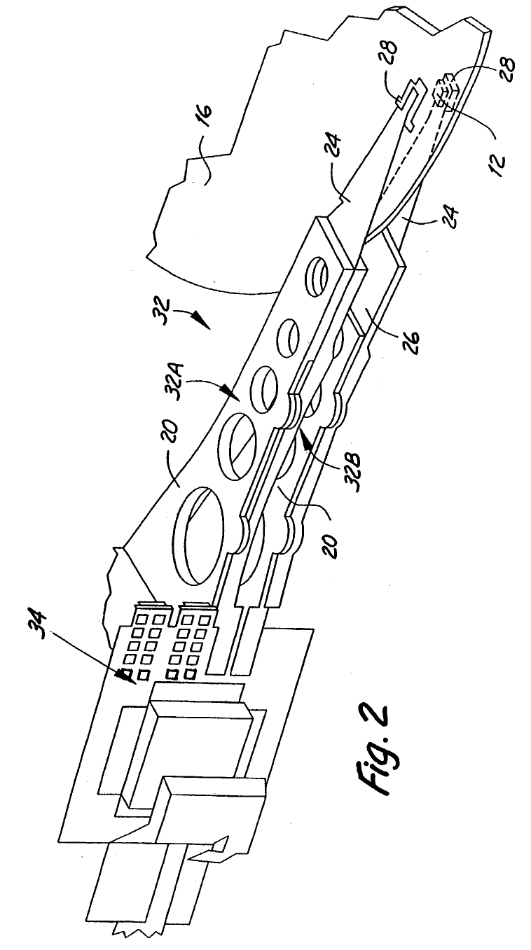

FIG. 2 is a perspective view of an actuation assembly 32 for positioning slider 12 over track 14 of disc 16. Actuation assembly 32 includes an upper assembly 32A and a lower assembly 32B that are identical. Both the upper assembly 32A and the lower assembly 32B include actuator arm 20 with load beam 24 connected to the actuator arm 20 at head mounting block 26. Gimbal 28 is connected to an end of load beam 24, and the slider 12 is attached to gimbal 28. Slider 12, carried by upper assembly 32A, reads and writes data from an upper surface of disc 16. Slider 12, located on lower assembly 32B, reads and writes data from the lower surface of disc 16. Also included is print circuit card (“PCC”) 34. PCC assembly 34 operates an additional component in the disc drive, such as a preamplifier.

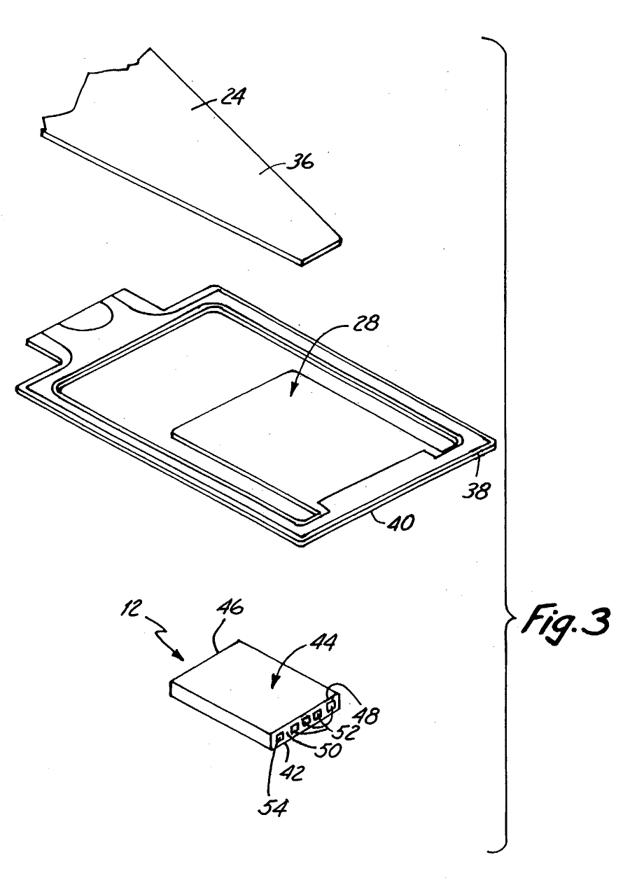

FIG. 3 is an exploded perspective view of the distal end portion of actuation assembly 32. Shown in FIG. 3, from the top to bottom are load beam 24, gimbal 28 and slider 12. Load beam 24 has a dimple (not shown) formed on the underside of load beam 24 at a distal end 36. Gimbal 28 is attached to load beam 24 relative to the dimple. A flex circuit material 38 is attached to a slider opposing face 40 of gimbal 28. Slider 12 attaches to gimbal 28 and is positioned on gimbal 28 such that slider 12 is centered on the dimple. Flex circuit material 38 is located between slider 12 and gimbal 28.

Slider 12 includes a disc opposing face 42 and a gimbal opposing face 44, which is attached to slider opposing face 40 on the bottom surface of gimbal 28. Slider 12 has a leading edge 46 and a trailing edge 48. A forward face 50 is disposed on trailing edge 48 of slider 12. Forward face 50 extends between the disc opposing face 42 and gimbal opposing face 44 at trailing edge 48. Slider bond pads 52 are formed on the forward face 50 of slider 12. In addition, a ground bond pad 54 is formed on forward face 50 of slider 12. In the embodiment of slider 12 shown in FIG. 3, four slider bond pads 52 and one slider ground pad 54 are formed on forward face 50. The resistance from slider ground pad 54 to a substrate of the slider body is approximately 1-10 ohms.

Gimbal 28 is configured to allow slider 12 to move in pitch and roll directions to compensate for fluctuations in the spinning surface of disc 16. Transducing head (not shown) is located on disc opposing face 42 of slider 12 proximate to trailing edge 48. In operation, load beam 24 and gimbal 28 carrying slider 12 move together as coarse positioning is performed by VCM 18 (FIG. 1) to rotate actuator arm 20 (FIG. 1).

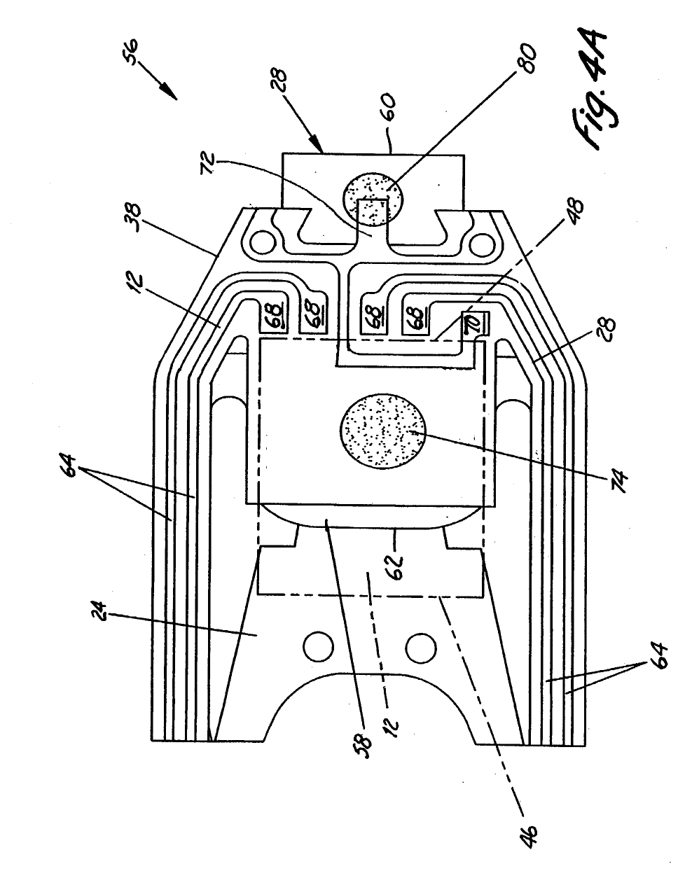

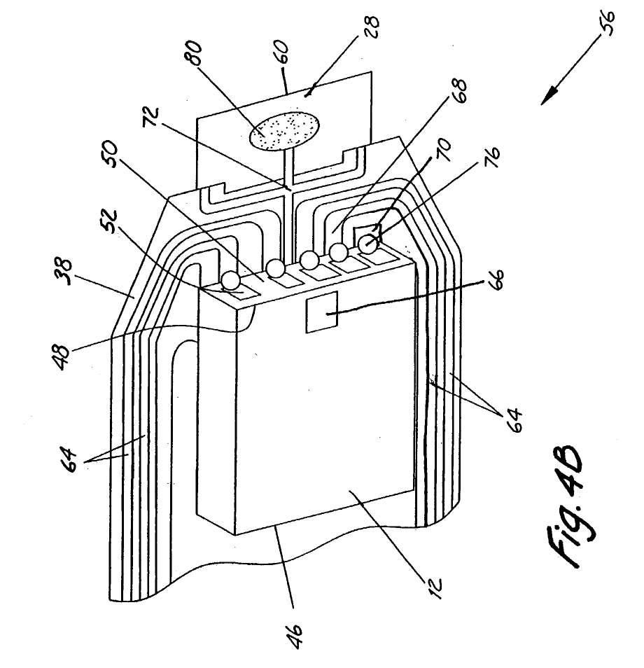

FIGS. 4A and 4B are bottom and a bottom perspective view, respectively, of one embodiment of an assembled distal portion of actuation assembly 32 of FIG. 3. Head gimbal assembly (HGA) design 56 includes gimbal 28, which is attached to load beam 24. Gimbal includes a gimbal tongue 58, a front edge 60 and a rear edge 62. Flex circuit material 38 is disposed on slider opposing face 40 (as seen in FIG. 3) of gimbal 28. In the embodiment of HGA design 56 shown in FIG. 4A, flex circuit material 38 is disposed on gimbal 28 where the slider 12 attaches. Flex circuit material 38 on slider opposing face 40 of gimbal 28 engages gimbal opposing face 44 (FIG. 3) of slider 12. Flex circuit material 38 generally travels along the underside, or disc side, of gimbal 28, load beam 24, and along the length of the actuator arm 20 (not shown) all the way to circuitry located in another part of the disc drive (not shown).

A trace layer 64 is disposed upon flex circuit material 38. Trace layer 64 completes a circuit connection between the electronic components of the disc drive (not shown) and a transducing head 66 carried by slider 12. Trace layer 64 travels along the underside of gimbal 28, load beam 24 and along the length of the actuator arm 20 on top of flex circuit material 38. Trace layer 64 is typically made of copper with gold plated on top of the copper layer. Each trace 64 ends at a flex on suspension (FOS) bond pad 68. In an exemplary embodiment there is at least one FOS bond pad 68 located on flex circuit material 38 for each active slider bond pad 52 located on slider 12. FOS bond pads 68 are preferably located proximate to gimbal tongue 58 adjacent front edge 60 of gimbal 28 and forward of where slider 12 is attached to gimbal 28. One skilled in the art would appreciate moving the FOS bond pads 68 to different locations of the FOS and moving the slider bond pads 52 to different locations of the slider without departing from the present invention.

Also formed on flex circuit material 38 is a ground FOS bond pad 70. There is at least one ground FOS bond pad 70 for slider ground pad 54 located on slider 12. Ground FOS bond pad 70 is located proximate to gimbal tongue 58 adjacent front edge 60 and forward of where slider 12 is attached to gimbal 28. A ground trace 72 of trace layer 64 extends from ground FOS bond pad 70 and terminates at a steel portion of gimbal 28 to ground.

Slider 12 has a disc opposing face (as viewed in FIG. 4B on the bottom of slider 12) and gimbal opposing face 44 (as viewed in FIG. 3 on top of the slider 12). Gimbal opposing face 44 is attached to gimbal 28 on slider opposing face 40 (as viewed in FIG. 4 on the bottom of gimbal 28) of gimbal 28. Transducing head 66 is located on disc opposing face 42 of slider 12. When slider 12 is attached to gimbal 28, forward face 50 of slider 12 is located proximate and substantially parallel to front edge 60 of gimbal. Thus, slider bond pads 52 and slider ground pad 54 located on forward face 50 of slider 12 are positioned proximate to FOS bond pads 68 and ground FOS bond pad 70, respectively. A structural adhesive 74 is used to bond slider 12 to gimbal 28 with flex circuit material 38 between slider 12 and gimbal 28.

When slider 12 is attached to gimbal 28, slider bond pads 52 are aligned with FOS bond pads 68 and slider ground pad 54 is aligned with ground FOS bond pad 70. A gold ball bond 76 is disposed on each slider pads 52, 54 (as seen in FIG. 4B). Ball bond 76 is bonded to slider pad 52 and 54 and the respective FOS bond pads 68, 70 to create an electrical connection between slider 12 and trace layer 60. Ball bonds 76 act as an electrical conduit and complete the electrical connection between slider 12 and trace layer 60. In further embodiments of the present invention lead bonds or solder connections may be used to electrically interconnect each slider pad 52, 54 and the respective FOS bond pads 68, 70.

Head gimbal assembly (HGA) manufacturers have implemented automation as a means for reducing labor and overhead costs. For example, slider 12 may be manufactured in bulk in an automated process. In addition, the ball bond interconnect design is used by most disc drive manufacturers because it is particularly suited for automated methods of electrically connecting the slider to gimbal 28. In addition to bonding, automation is also used to place slider 12 on flex circuit material 38 with respect to the dimple so that the slider bond pads 52 are aligned with FOS bond pads 68 and slider ground pad 54 is aligned with ground FOS bond pad 70.

Large currents or voltages associated with the charging or discharging of the transducer by electrostatic charge sources may possibly damage the reader element. Electrostatic charge may be generated any time during the fabrication, assembly, testing and shipment of the disc drive. Specifically, electrostatic charge may be generated during fabrication of the magnetoresistive head assembly, the head gimbal assembly E-block assembly, the final disc drive, electrical testing of components and shipment of the components. In response, various procedures and equipment have been installed to control electrostatic discharge (ESD) levels during every stage of handling through final disc drive assembly to prevent damage to the reader element caused by ESD.

To safeguard the transducer of slider 12 from possible electrostatic discharge and improving the conductivity of the discharge path between the slider and suspension, the HGA design 56 includes ground trace 72 and slider 12 includes ground pad 54. Ground trace 72 includes ground FOS bond pad 70 so that slider 12 will be electrically connected to ground trace 72. From ground FOS bond pad 70, ground trace 72 extends beyond the trailing edge 48 of slider 12. Ground trace 72 further extends beyond flex circuit material 38 to front edge 60 of gimbal 28, which is typically steel. Ground trace 72 is connected to conductive tack 80 by a conductive adhesive. Conductive tack 80 is located beyond the gimbal bond area (area where slider 12 attaches to gimbal 28), but on gimbal 28. The conductive adhesive is comprised of a stiff adhesive to provide good conductivity and is highly conductive, for example a silver filled epoxy adhesive may be used. Gimbal 28 is connected to the load beam 24, and load beam 24 is grounded. HGA design 56 provides a resistance from slider ground pad 54 to conductive tack 80 of less than 100 ohms. The HGA design 56 also provides a grounding system that places slider 12 at the same electrical potential as the other mechanical components and electrical ground components, which improves bit error rate (BER), reduces system noise, and matches electrostatic discharge/ EOS wafer design protection feature requirements.

Slider ground pad 54 and ground FOS bond pad 70 of the present invention provide a low impedance ground connection from slider 12 to ground. The low resistivity ground connection reduces signal-to-noise ratio within the disc drive and increases the reliability for discharging the electrostatic charge within slider 12. In addition, slider ground pad 54 is formed in slider 12 at the same time and using the same method as slider bond pads 52. Thus, there are no additional manufacturing steps or costs for including slider ground pad 54 in the present invention slider. In addition, the low impedance ground connection using slider ground pad 54 removes the issues associated with a conductive adhesive to attach the slider to the gimbal, such as non-parallel connection between the two and weak interconnect.

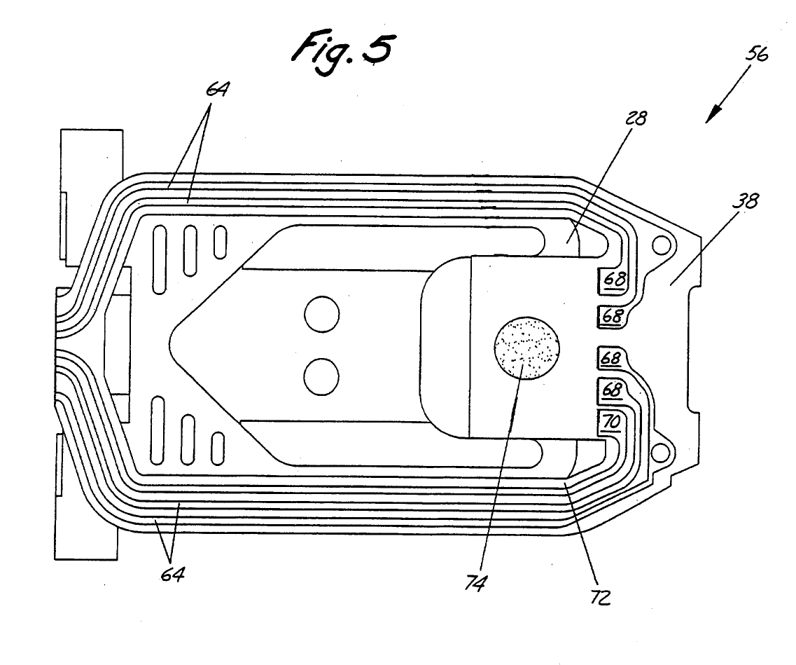

FIGS. 5-7 include features and advantages similar to FIGS. 4A-4B, therefore only the differences will be illustrated. It should be understood that slider 12 is assembled and connected to the HGA design in FIGS. 5-7 similarly to how slider 12 is shown in FIGS. 4A and 4B and previously described.

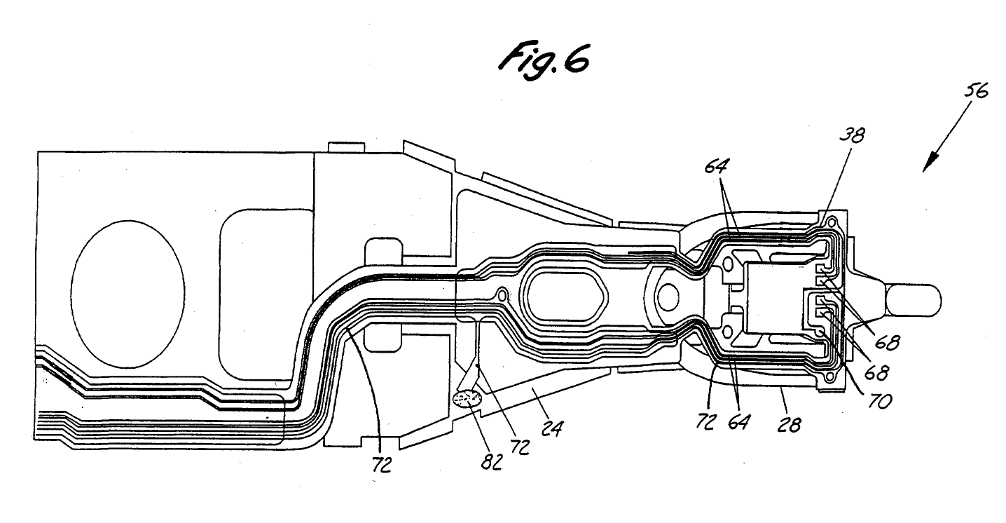

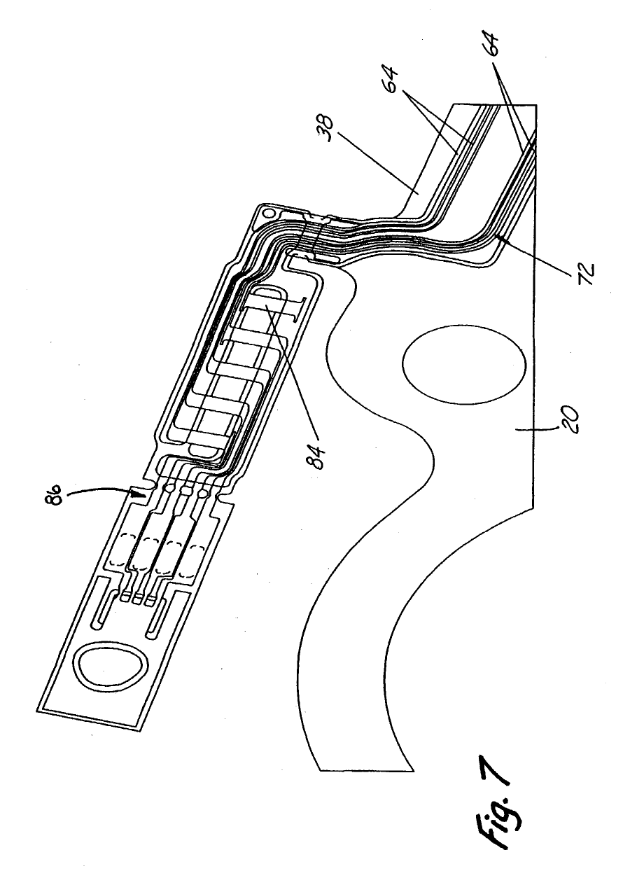

FIG. 5 is a bottom view of another embodiment of an assembled distal portion of the actuation system 32 of FIG. 3 and HGA design 56 of FIGS. 4A and 4B. In HGA design 56 of FIG. 5, ground trace 72 extends back to a conductive tack on load beam 24 (shown in FIG. 6) and/or PCC assembly 34 (shown in FIGS. 2 and 7) to ground slider 12 rather than a conductive tack on gimbal 24 (as seen in FIGS. 4A and 4B). Ground trace 72 extends along flex circuit material 38 on the disc side of gimbal 28, load beam 24 and actuator arm 20.

FIG. 6 is a bottom view of actuation assembly 32 and HGA design 56. Ground trace 72 extends along flex circuit material 38 attached to the disc side of gimbal 28 and load beam 24. In this embodiment, ground trace 72 is terminated at a conductive tack 82 formed on load beam 24 by a conductive adhesive, thereby providing a path to ground. The conductive adhesive is a highly conductive adhesive, such as silver filled epoxy adhesive. This embodiment of HGA design 56 provides a resistance from slider bond pad 54 to conductive tack 82 of less than 100 ohms.

FIG. 7 is a bottom view of a distal end portion of actuator arm 20. FIG. 7 shows ground trace 72 extending back to a ground pad 84 located on a flex circuit tail 86. Pad 84 is bonded flex circuit tail 86 and flex circuit tail 86 is attached to PCC assembly 34 (shown in FIG. 2), which is grounded to the disc drive body (not shown). PCC assembly 34 is either grounded to an actuator of the disc drive, such as the VCM 18, or a printed circuit board. This embodiment of HGA design 56 provides a resistance from slider bond pad 54 to PCC assembly 34 of approximately 5-12 ohms. Both embodiments shown in FIGS. 6 and 7 and herein described may be simultaneously grounded to gimbal 28 as shown in FIGS. 4A and 4B.

Although the present invention has been described with references to preferred embodiments, workers skilled in the art will recognize that changes may be made in form and detail without departing from the spirit and scope of the invention.

1. A slider for supporting a transducing head proximate a rotating disc, the slider comprising:
a slider body having a leading edge and a trailing edge, a forward face adjacent the trailing edge;
a slider bond pad located on the forward face; and
a slider ground pad located on the slider body for interconnecting with a ground trace.

2. The slider of claim 1 wherein a resistance from the slider ground pad to the slider body is about 1 ohms to about 10 ohms.

3. An improved suspension assembly comprising:
a suspension including a load beam and a gimbal connected to a distal end of the load beam, the gimbal having a slider opposing face;
a slider supporting a transducing head and the slider supported by the slider opposing face of the gimbal, the slider comprising:
a slider body having a gimbal opposing face and a disc opposing face, the slider body having a forward face extending between the gimbal opposing face and the disc opposing face;
a slider bond pad located on the forward face,
a slider ground pad located on the forward face; and
a ground trace interconnected with the slider ground pad.

4. The improved suspension assembly of claim 3 wherein the ground trace is terminated to the suspension.

5. The improved suspension assembly of claim 4 wherein a resistance between the ground trace and the suspension is less than 100 ohms.

6. The improved suspension assembly of claim 4 wherein the ground trace is electrically connected to the gimbal adjacent a forward edge of the gimbal, the ground trace connected to the gimbal with a highly conductive adhesive.

7. The improved suspension assembly of claim 6 wherein the highly conductive adhesive is a silver-filled epoxy adhesive.

8. The improved suspension assembly of claim 4 wherein the ground trace is electrically connected to the load beam at a conductive tack, the conductive tack comprised of a highly conductive adhesive located at a proximal end of the load beam.

9. The improved suspension assembly of claim 3 wherein the ground trace extends along the slider opposing face of the gimbal and the load beam, the ground trace terminated at a printed circuit card assembly.

10. The improved suspension assembly of claim 9 wherein a resistance from the ground trace to the printed circuit card assembly is about 5 ohms to about 12 ohms.

11. The improved suspension assembly of claim 3 wherein the gimbal further comprises a flex circuit material on the slider opposing face and a plurality of flex on suspension (FOS) bond pads located on the flex circuit material, and wherein the FOS bond pads include a ground FOS bond pad located on the flex circuit material such that the slider ground pad is aligned with the ground FOS bond pad.

12. The improved suspension assembly of claim 11 wherein the ground trace is connected to the ground FOS bond pad and the slider ground pad is connected to the ground FOS bond pad by a ball bond.

13. A disc drive comprising:
a movable actuator arm;
a suspension including a load beam supported by a distal end of the actuator arm and a gimbal connected to a distal end of the load beam, the gimbal having a slider opposing face and a forward edge;
a slider supporting a transducing head and the slider supported by the slider opposing face of the gimbal; and
a ground trace having a first end and a second end, the first end of the ground trace electrically connected to the slider and the second end terminated at the suspension.

14. The disc drive of claim 13 wherein the second end of the ground trace is terminated at a conductive tack positioned adjacent the forward edge of the gimbal.

15. The disc drive of claim 14 wherein the conductive tack is comprised of a highly conductive adhesive.

16. The disc drive of claim 13 wherein the ground trace connects with a conductive tack positioned at a proximal end of the load beam.

17. The disc drive of claim 13, and further comprising a printed circuit card assembly connected to a proximal end of the actuator arm.

18. The disc drive of claim 17 wherein the second end of the ground trace is terminated at the printed circuit card assembly wherein the ground trace extends along the gimbal, the load beam and the actuator arm.

19. The disc drive of claim 13 wherein the slider comprises:
a slider body having a gimbal opposing face and a disc opposing face and the slider body having a forward face extending between the gimbal opposing face and the disc opposing face;
a slider bond pad located on the forward face; and
a slider ground pad located on the forward face and interconnected with the transducing head wherein the first end of the ground trace is interconnected with the slider ground pad of the slider body.

20. The disc drive of claim 19 wherein the gimbal further comprises a flex circuit material on the slider opposing face and a plurality of flex on suspension (FOS) bond pads located on the flex circuit material, and further wherein the FOS bond pads includes a ground FOS bond pad located on the flex circuit material such that the slider ground pad is aligned with the ground FOS bond pad.

21. The disc drive of claim 20 wherein the ground trace is connected to the ground FOS bond pad and the slider ground pad is connected to the ground FOS bond pad by a ball bond.

22. A disc drive comprising:
a movable actuator arm,
a suspension including a load beam supported by a distal end of the actuator arm and a gimbal connected to a distal end of the load beam, the gimbal having a slider opposing face and a forward edge,
a flex circuit material disposed on the actuator arm and the suspension;
flex on suspension (FOS) bond pads disposed on the slider opposing face of the gimbal adjacent the forward edge of the gimbal, the FOS bond pads including a ground FOS bond pad;
a conductive trace extending from each of the FOS bond pads wherein at least one of the conductive traces is a ground trace extending from the ground FOS bond pad;
a slider supporting a transducing head and the slider supported by the slider opposing face of the gimbal with the flex circuit material therebetween, the slider comprising:
a slider body having a leading edge and a trailing edge and the slider body having a forward face adjacent the trailing edge; and
slider bond pads located on the forward face, wherein each slider bond pad is aligned with one FOS bond pad;
a slider ground pad located on the forward face wherein the slider ground pad is aligned with and connected to the ground FOS bond pad.

23. The disc drive of claim 22 wherein the ground trace is terminated on the gimbal with a highly conductive adhesive adjacent the forward edge of the gimbal.

24. The disc drive of claim 22 wherein the ground trace is terminated on the load beam with a highly conductive adhesive adjacent the actuator arm.

25. The disc drive of claim 22 wherein the ground trace is terminated at a printed circuit card assembly connected to the actuator arm.
